(19) United States
(12) Patent Application Publication
(10) Pub. No.: US 2014/0071613 A1
(43) Pub. Date: Mar. 13, 2014

(54) GEOTHERMAL COOLING FOR MODULAR DATA CENTERS

(71) Applicant: DEEPAK K. JAIN, Beltsville, MD (US)

(72) Inventor: DEEPAK K. JAIN, Beltsville, MD (US)

(73) Assignee: AiNET Registry, LLC, Beltsville, MD (US)

(21) Appl. No.: 13/607,421

(22) Filed: Sep. 7, 2012

(51) Int. Cl. G06F 1/20

(52) U.S. Cl. 361/679.46

(57) ABSTRACT

A cooling system for cooling a heat producing module includes a heat dissipation system and at least one cooling loop. The heat dissipation system is in thermal communication with the heat producing module and contains coolant flowing therethrough. The at least one cooling loop is disposed beneath the surface of the Earth and directly underneath a footprint of the heat producing module. The at least one cooling loop is coupled to the heat dissipation system to receive the coolant from the heat dissipation system and to dissipate the heat from the coolant to the Earth. The at least one cooling loop is completely contained within the footprint of the heat producing module in order to minimize the ecological impact.

### BACKGROUND

The present disclosure relates to a cooling system for cooling a heat producing module.

Portable computer containers typically include computing equipment or computing resources, such as high density servers, storage equipment, and/or networking equipment, deployed in standard shipping containers. Portable computer containers can be deployed in environments with fewer of the traditional datacenter infrastructure considerations.

The computing equipment in these portable computer containers consume electrical energy for their operation and dissipate heat as a result of this energy consumption. Also, proper operation of the computing equipment depends on maintaining their ambient temperature within a specified range. Therefore, such portable computer containers require a cooling mechanism. Typically, a heat-exchanger system (with one or more heat-exchangers) is deployed inside the portable computer container to capture heat and transfer the heat out of the portable computer container. This system typically uses chilled water provided by on-site chillers (also deployable by the portable computer containers). This system is often shared between numerous portable computer containers allowing for undesirable single-points-of-failure (SPOF) at the chiller, or in the cooling “loop.”

Embodiments of the present disclosure provide improvements over the conventional cooling mechanism for enclosures having heat producing components.

### SUMMARY

One embodiment relates to a cooling system for cooling a heat producing module. The cooling system includes a heat dissipation system and a plurality of cooling loops. The heat dissipation system is in thermal communication with the heat producing module and contains coolant flowing therethrough. The cooling loops are disposed beneath the surface of the Earth and directly underneath a footprint of the heat producing module. At least two cooling loops are coupled to the heat dissipation system to receive the coolant from the heat dissipation system and to dissipate the heat from the coolant to the Earth. The cooling loops are completely contained within the footprint of the heat producing module in order to minimize an ecological impact.

Another embodiment relates to a system that includes at least two enclosures and a plurality of cooling loops. The at least two enclosures are disposed one on top of another in a vertically stacked configuration and aligned in parallel with one another in space. Each enclosure includes a plurality of heat producing components and a heat dissipation system in thermal communication with the heat producing components and contains coolant flowing therethrough. The cooling loops are disposed beneath the surface of the Earth and directly underneath a footprint of the enclosures. At least two cooling loops are coupled to the heat dissipation systems of the at least two enclosures to receive the coolant from the heat dissipation systems and to dissipate the heat from the coolant to the Earth. The cooling loops are completely contained within the footprint of the enclosures in order to minimize the ecological impact. Two or more coolants may be used in separate cooling loops.

These and other aspects of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one example of the present disclosure, the structural components illustrated herein can be considered drawn to scale. It is to be expressly understood, however, that many other configurations are possible and that the drawings are for the purpose of example, illustration and description only and are not intended as a definition or to limit the scope of the present disclosure. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

Various embodiments will now be disclosed, by way of example only, with reference to the accompanying schematic drawings in which corresponding reference symbols indicate corresponding parts, in which:

FIG. 1 illustrates a cooling system for cooling a heat producing module in accordance with an embodiment of the present disclosure;

FIG. 2 illustrates a cooling system for cooling at least two enclosures in accordance with an embodiment of the present disclosure; and

FIG. 3 illustrates a cooling system for cooling at least two enclosures in accordance with another embodiment of the present disclosure.

### DETAILED DESCRIPTION

The present disclosure proposes using a geothermal cooling system for portable computer containers to provide “green” or environmentally sustainable computing. Green or environmentally sustainable computing, as used herein, generally refers to practices for using computing systems efficiently and effectively with minimal impact on the environment. The proposed geothermal cooling for portable computer containers provides improved efficiency, improved reliability and fewer operational costs.

Geothermal cooling is a highly efficient cooling technique that uses a fluid (not chilled water) to transfer heat to the earth in a closed system. For example, pipes may be connected to an inlet and an outlet of a heat dissipation system, and the pipes placed underground so as to remove the heat from any heat producing system and dissipate the heat to the ground. The proposed cooling system may be used to cool several disparate electronic components that act independently or as a system.

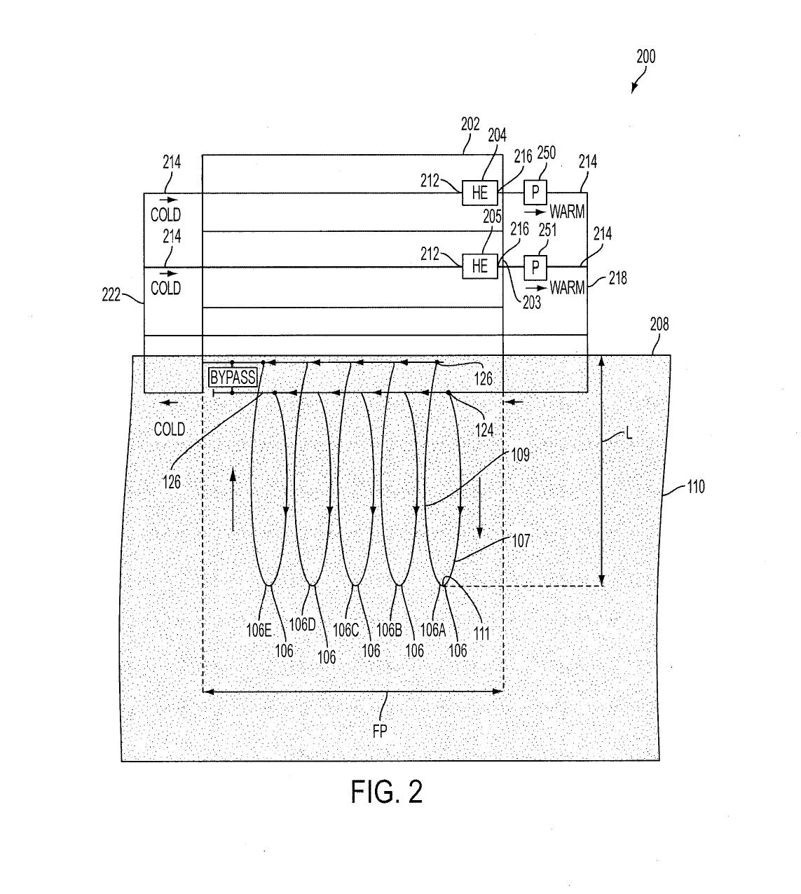

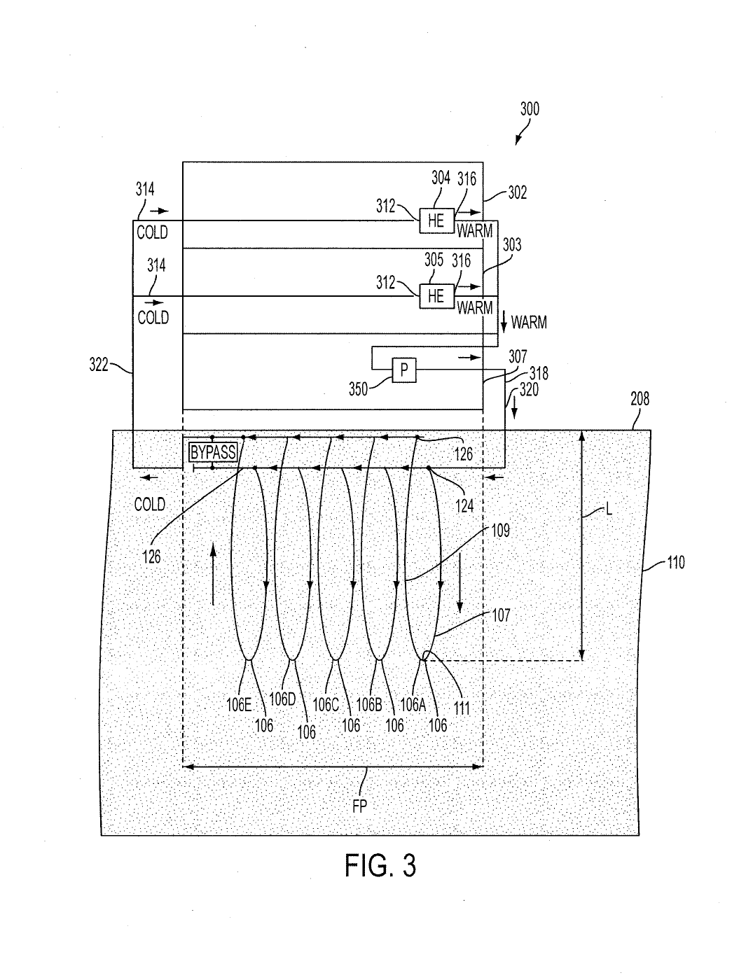

A geothermal cooling system of the present disclosure may utilize multiple parallel flows directly underneath the thermal space of a portable computer container for space-efficiency purposes and to minimize the effects on the environment. That is, such an orientation for the cooling loops provides the benefit of increasing the surface area of the cooling loops that contacts the ground, while limiting the area that would be needed to install the cooling loops. Efficiency, as used herein, may be referred to as amount of cooling per square feet or cubic feet. As will be described with respect to FIGS. 2 and 3, the present disclosure also proposes multiple cooled spaces that share one or more loops simultaneously.

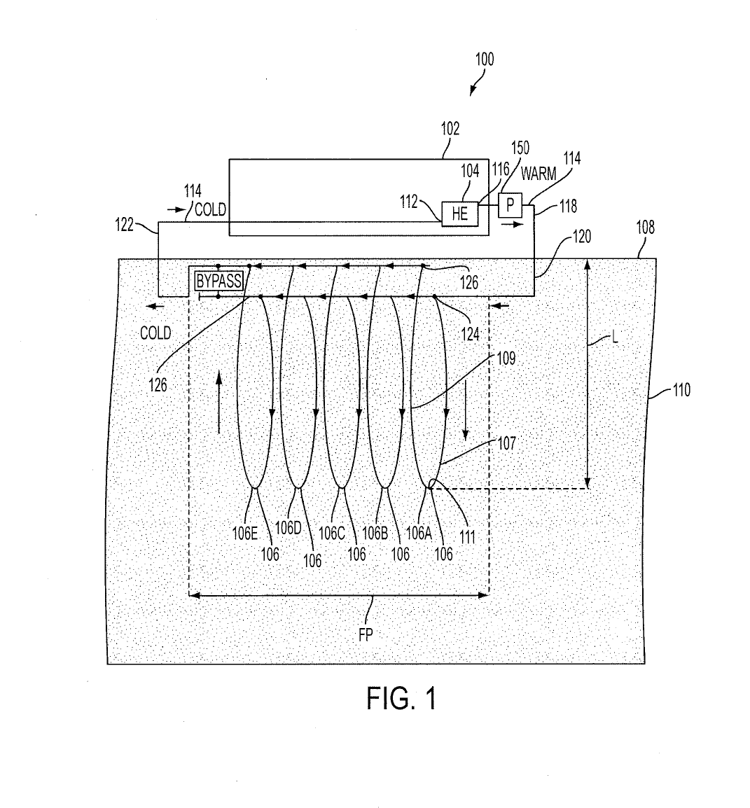

In one embodiment, cooling system 100 for cooling heat producing module 102 is shown in FIG. 1. Cooling system 100 includes heat dissipation system 104 and plurality of cooling loops 106. Heat dissipation system 104 is in thermal communication with heat producing module 102 and contains coolant 114 flowing therethrough. Plurality of cooling loops 106 is disposed beneath surface 108 of Earth 110 and directly underneath footprint FP of heat producing module 102. At least two cooling loops 106 may be coupled to heat dissipation system 104, to receive coolant 114 from heat dissipation system 104 and to dissipate the heat from coolant 114 to Earth 110. Cooling loops 106 are completely contained within footprint FP of heat producing module 102 in order to minimize the ecological impact.

Heat producing module 102 may be a standard shipping container, such as a standard forty foot ISO (International Standard Organization) shipping container. Heat producing module 102 may be a semi-mobile installation or a permanent installation. Heat producing module 102 may be quickly deployed to remote job sites via sea, rail or road by using a transport vehicle, such as a tractor truck and trailer.

Heat producing module 102 may be an electronic enclosure having one or more electronic components. For example, heat producing module 102 may be a portable computer container. The electronic components are selected from the group consisting of servers, switches, data processing systems. data storage systems, networking systems, printing equipment, integrated semiconductor chips, transistors, capacitors, inductors, relays, transformers, and base station for wireless communications.

Cooling system 100 may also include manifold 118 having supply line 120 and return line 122. Supply line 120 of manifold 118 is connected to outlet 116 of heat dissipation system 104 and return line 122 of manifold 118 is connected to inlet 112 of heat dissipation system 104. In one embodiment, manifold 118 including supply line 120 and return line 122 is made from a material, e.g., a metal, plastic or composite material as is known, although other materials or combination of materials may be used.

In one embodiment, the heat dissipation system is a heat exchanger. In another embodiment, the heat dissipation system is a water-based system that is configured to receive water from the water-based system so as to dissipate the heat of the heat producing module 102. Yet in another embodiment, the heat dissipation system is a coolant-based system that is configured to receive coolant from the coolant-based system so as to dissipate the heat of the heat producing module 102.

Cooling loops 106 disposed beneath surface 108 of Earth 110 may be connected to manifold 118. In the illustrated embodiment, most portions of supply line 120 and return line 122 are disposed beneath surface 108 of Earth 110, while other portions of supply line 120 and return line 122 are disposed above surface 108 of Earth 110.

In the illustrated embodiment, as just one example is shown in FIG. 1, cooling loops 106 may include five cooling loops 106A-E disposed beneath surface 108 of Earth 110. However, the number of cooling loops 106 disposed beneath surface 108 of Earth 110 can vary significantly in number. In one embodiment, the number of cooling loops 106 may depend on the cooling load or demand of heat producing module 102.

In the illustrated embodiment, cooling loops 106 are run vertically in the ground. Cooling loops 106A-E may be structurally identical to each other, but denoted by different reference characters for illustrative purposes. Cooling loops 106A-E are disposed generally parallel to each other. Length and size (e.g., diameter) of cooling loops 106 may depend of various factors, such as average ground temperature, thermal conductivity of the ground, soil moisture, and/or cooling demands of heat producing module 102.

Each cooling loop 106 may extend distance L from surface 108 of Earth 110 to provide a temperature gradient between first end 124 and second end 126 of cooling loop 106. The temperature of warm coolant 114 falls as it passes through cooling loops 106 as heat is transferred from warm coolant 114 to Earth 110. In one embodiment, temperature gradient between first end 124 of cooling loop 106A and second end 126 of cooling loop 106E may be around 5° C. That is, the temperature of coolant 114 at first end 124 of cooling loop 106A may be around 85° C. and the temperature at second end 126 of cooling loop 106E may be around 80° C.

In one embodiment, a by-pass or a three way valve may be positioned near second end 126. The by-pass valve may be utilized to by-pass various elements of cooling system 100 and to allow for maintenance of elements of cooling system 100. In one embodiment, the by-pass valve may be a single valve or multiple valves, positioned at beginning, end or in between the loops. In one embodiment, the by-pass valve is a manual by-pass valve. In one embodiment, the by-pass valve may be used to provide for system operation in the event of contamination, damage or blockage to one or more of the cooling loops 106.

In one embodiment, universal connectors are positioned near portions of supply line 120 and return line 122 (that are disposed above surface 108 of Earth 110). Such connectors may be used for easy assembly (hook-up) and/or disassembly of input coolant line and output coolant lines of heat producing module 102 with return line 122 and supply line 120, respectively.

Each cooling loop 106 may include two pipes 107 and 109 connected to each other using a U-shaped joint 111. In one embodiment, pipes 107 and 109, and joint 111 are made from a piping material, although other materials or combination of materials may be used. In one embodiment, pipes 107 and 109, and joint 111 may be made from a material that promotes heat transfer between warm coolant 114 and Earth 110 and allows for passage of coolant 114 therethrough.

Cooling loops 106 disposed beneath surface 108 of Earth 110 are directly underneath footprint FP of heat producing module 102. Extending the cooling loops outside the footprint of the heat producing module may impact the cooling density Therefore, ground cooling loops 106 of the present disclosure may be placed directly underneath the thermal space of heat producing module 102. Placing ground cooling loops 106 directly underneath the thermal space of heat producing module 102 improves space efficiency. Placing geothermal cooling loops 106 into the ground directly under portable computer containers 102 themselves not only reduces the amount of square footage or acreage required for a large deployment, but also adds redundancy for geothermal cooling loops 106. This will reduce the amount of energy required to pump coolant 114 through cooling loops 106, reducing pump requirements and improving Power Usage Effectiveness (PUE). In general, PUE is a measure of how efficiently a computer data center or container uses its power; specifically, how much of the power is actually used by the computing equipment (in contrast to cooling and other overhead). PUE is the ratio of total amount of power used by a computer data center facility or container to the power delivered to computing equipment.

In another embodiment, instead of multiple parallel flow cooling loops, cooling system 100 may include one or more cooling loops in a helical (coiled) or a spiral configuration. A cooling system with this configuration also has a smaller footprint and therefore provides more efficient use of space. Coolant 114 from supply line 120 enters helical (coiled) or a spiral cooling loop(s). Coolant 114 then passes through the coils of the cooling loop(s) to transfer heat from coolant 114 to Earth 110. Coolant 114 then passes through a delivery line that connects the end of the coils to return line 122.

Heat exchanger 104 includes inlet 112 through which coolant 114 enters heat exchanger 104 and outlet 116 through which coolant 114 exits heat exchanger 104.

Heat exchanger 104 may be any suitable type of heat exchanger such as, for example, a natural convection heat exchanger or a forced air heat exchanger. Heat exchanger 104 may include pipes through which coolant 114 flows through heat exchanger 104. Heat exchanger 104 may include a plurality of fins (not shown) connected to pipes. Heat from the components of heat producing module 102 may be drawn through the fins to the pipes containing coolant 114 so that heat is transferred from the components of heat producing module 102 to coolant 114. The heat accumulated by coolant 114 is then transferred from coolant 114 to a heat sink (i.e., Earth 110).

Heat exchanger 104 may be a tube-fin type heat exchanger, a plate type heat exchanger, or any other type of heat exchanger known to one skilled in the art. In one embodiment, heat exchanger 104 may be positioned horizontally to the floor of heat producing module 102.

Coolant 114 warms as it is circulated through heat exchanger 104 and warm coolant flows out of outlet 116. Warm coolant is then supplied to cooling loops 106 via supply line 120 of manifold 118. After coolant 114 passes through cooling loops 106, “cold” coolant 114 is returned through return line 122 of manifold 118 to inlet 112 of heat exchanger 104. Coolant 114 serves as a heat transfer medium.

Coolant 114 may be selected from different materials such as ethylene glycol, Freon® (i.e., a mixture of chlorofluorocarbon and hydrochlorofluorocarbon), and Puron® (i.e., a mixture of difluromethane and pentafluoroethane).

In some embodiments, the same coolant may be used in both the heat exchanger and the cooling loops. In other embodiments, two different coolants are used in the cooling system. That is, geothermal cooling (cooling loops) may use a first type of coolant to reject heat with the earth in a closed system, while the heat exchanger may use a second type of coolant. For example, a small water (second type of coolant) based loop of a plate type heat exchanger may transfer heat to the first type of coolant in the geosynchronous cooling loop.

In some embodiments, usage of water in the heat exchanger may be reduced or eliminated by using the same coolant in the geothermal loop and in the heat exchanger in the portable computer containers. Alternatively, reduction in usage of water may also be possible by using a plate-style heat exchanger (or similar) to transfer heat from a smaller water-based loop to the geothermal loop, e.g., by utilizing a separate pump.

In one embodiment, cooling system 100 may include pump 150 to facilitate pressurized flow of coolant 114 through cooling loops 106. In the illustrated embodiment, pump 150 may be located outside heat producing module 102. In another embodiment, pump 150 may be located inside heat producing module 102.

In some embodiments, pump 150 does not perform any mechanical compression of coolant 114. That is, pump 150 does not operate a compressor and simply moves coolant 114 under low pressure for passive heat transfer.

In other embodiments, when the cooling demands of heat producing module 102 are low, then pump 150 may be switched off, and simple fluid gradients may be used to move the coolant through cooling loops 106.

In some embodiments, the only energy applied to cooling system 100 is the energy applied to operate low-pressure pump 150, which pumps the coolant or fluid through both the internal exchanger (heat exchanger 104) and the external exchanger (i.e., plurality of cooling loops 106) in ground 110.

FIG. 2 discloses cooling system 200 for cooling at least two enclosures 202 and 203 in accordance with an embodiment of the present disclosure. In the illustrated embodiment, as just one example is shown in FIG. 2, cooling system 200 is configured for cooling two enclosures 202 and 203. However, the number of enclosures that cooling system 200 cools can vary significantly in number.

System 200 includes two enclosures 202 and 203 disposed one on top of another in a vertically stacked configuration and aligned in parallel with one another in space. Each enclosure 202 or 203 includes a plurality of heat producing components and heat exchanger 204 or 205 in thermal communication with the heat producing components and contains coolant 214 flowing therethrough. System 200 also includes plurality of cooling loops 206 disposed beneath surface 208 of Earth 210 and directly underneath a footprint FP of enclosures 202 and 203, at least two cooling loops 206 coupled to heat exchangers 204 and 205 of at least two enclosures 202 and 203 to receive coolants 214 from heat exchangers 204 and 205 and to dissipate the heat from coolants 214 to Earth 210. Cooling loops 206 are completely contained within the footprint of the enclosures 202 and 203 in order to minimize the ecological impact.

In one embodiment, two enclosures 202 and 203 disposed one on top of another such that two enclosures 202 and 203 have a common or same footprint. That is, two enclosures 202 and 203 are stacked and aligned within the same footprint.

Each of enclosures 202 and 203 may be structurally and functionally similar to heat producing module 102 described in the earlier embodiment, therefore, enclosures 202 and 203 are not described in detail here.

Also, the structure and function of various components including cooling loops 206 and heat exchangers 204 and 205 of cooling system 200 are similar to that of components (i.e., cooling loops 106 and heat exchanger 104) of cooling system 100 described in the earlier embodiment. Therefore, the structure and function of cooling loops 206 and heat exchangers 204 and 205 of cooling system 200 are not described in detail here.

Cooling system 200 may further include pumps 250 and 251 to facilitate the flow of coolants 214 from heat exchangers 204 and 205 through at least two cooling loops 206. Pumps 250 and 251 may be located either inside or outside their respective enclosures 202 and 203.

FIG. 3 illustrates cooling system 300 for cooling at least two enclosures 302 and 303 in accordance with another embodiment of the present disclosure. Cooling system 300 is the same as cooling system 200 described in the earlier embodiment, but may have the following differences.

In addition to enclosures 302 and 303, cooling system 300 may include third enclosure 307 disposed in a vertically stacked configuration with first two enclosures 302 and 303 and aligned in parallel with enclosures 302 and 303. Enclosure 307 includes pump 350 to facilitate the flow of coolants 314 from heat exchangers 304 and 305 through at least two cooling loops 306. In one embodiment, third enclosure 307 may be disposed directly under first two enclosures 302 and 303.

In describing the present disclosure, reference is made to various examples using portable computer containers to describe the system of the present disclosure. Generalization to other systems that require a large amount of thermal exchange is straightforward, however, and the use of particular examples using portable computer containers is not intended to limit the scope of the present disclosure. For example, the cooling system of the present disclosure can be used in any industrial process that requires significant continuous or routine thermal exchange including industrial and building cooling systems (e.g. solar panels, smelters, chillers), high capacitance systems (e.g. rail guns, UPS systems), etc.

Although the present disclosure has been described in detail for the purpose of illustration, it is to be understood that such detail is solely for that purpose and that the inventive concept is not limited to the disclosed embodiments, but, on the contrary, is intended to cover modifications and equivalent arrangements that are within the spirit and scope of the appended claims. In addition, it is to be understood that the present disclosure contemplates that, to the extent possible, one or more features of any embodiment may be combined with one or more features of any other embodiment.

What is claimed is:

1. A cooling system for cooling a heat producing module, the cooling system comprising:
a heat dissipation system in thermal communication with the heat producing module and containing coolant flowing therethrough; and
at least one cooling loop disposed beneath a surface of the Earth and directly underneath a footprint of the heat producing module, wherein the at least one cooling loop is coupled to the heat dissipation system to receive the coolant from the heat dissipation system and to dissipate the heat from the coolant to the Earth, and wherein the at least one cooling loop is completely contained within the footprint of the heat producing module to reduce an ecological impact.

2. The cooling system of claim 1, wherein the at least one cooling loop extends a distance from the surface of the Earth to provide a temperature gradient between a first end and a second end of the at least one cooling loop.

3. The cooling system of claim 1, further comprising a pump to facilitate the flow of the coolant through the at least one cooling loop.

4. The cooling system of claim 3, wherein the pump is disposed outside the heat producing module.

5. The cooling system of claim 1, wherein the at least one cooling loop comprises a plurality of cooling loops disposed parallel to each other, and wherein the plurality of cooling loops are coupled to the heat dissipation system to receive the coolant from the heat dissipation system and to dissipate the heat from the coolant to the Earth.

6. The cooling system of claim 1, wherein the heat producing module is an electronic enclosure having one or more electronic components contained therein.

7. The cooling system of claim 6, wherein the electronic components are selected from the group consisting of servers, switches, data processing systems, data storage systems, networking systems, printing equipment, integrated semiconductor chips, transistors, capacitors, inductors, relays, transformers, and a base station for wireless communications.

8. The cooling system of claim 1, wherein the coolant is selected from the group consisting of ethylene glycol, a mixture of chlorofluorocarbon and hydrochlorofluorocarbon, and a mixture of difluromethane and pentafluoroethane.

9. The cooling system of claim 1, wherein the heat producing module is an ISO standard shipping container.

10. The cooling system of claim 1, wherein the heat dissipation system is a heat exchanger.

11. The cooling system of claim 1, wherein the heat dissipation system is a water-based heat dissipation system.

12. A system comprising:
at least two enclosures disposed one on top of another in a vertically stacked configuration and aligned in parallel with one another in space, each enclosure comprising a plurality of heat producing components and comprising a heat dissipation system in thermal communication with the heat producing components and containing coolant flowing therethrough; and
at least one cooling loop disposed beneath the surface of the Earth and directly underneath a footprint of the enclosures, wherein the at least one cooling loop is coupled to the heat dissipation systems of the at least two enclosures to receive the coolant from the heat dissipation systems and to dissipate the heat from the coolant to the Earth,
wherein the at least one cooling loop is completely contained within the footprint of the enclosures to reduce an ecological impact.

13. The system of claim 12, further comprising a third enclosure disposed in a vertically stacked configuration with the at least two enclosures and aligned in registration with the at least two enclosures, wherein the third enclosure comprises a pump to facilitate the flow of the coolants from the heat dissipation systems through the at least one cooling loop.
